(19) United States
(12) Patent Application Publication
(10) Pub. No.: US 2025/0116593 A1
(43) Pub. Date: Apr. 10, 2025

(54) ASSAY DETECTION, ACCURACY AND RELIABILITY IMPROVEMENT

(71) Applicant: Essenlix Corporation, Monmouth Junction, NJ (US)

(72) Inventors: Stephen Y. CHOU, Princeton, NJ (US); Wu CHOU, Basking Ridge, NJ (US); Xing LI, Metuchen, NJ (US); Hongbing LI, Skillman, NJ (US); Yuecheng Zhang, Yardley, PA (US); Mingquan WU, Princeton Junction, NJ (US); Wei DING, Princeton, NJ (US); Jun TIAN, Belle Mead, NJ (US)

(73) Assignee: Essenlix Corporation, Monmouth Junction, NJ (US)

(21) Appl. No.: 18/739,128

(22) Filed: Jun. 10, 2024

Related U.S. Application Data
(63) Continuation of application No. 18/215,302, filed on Jun. 28, 2023, now Pat. No. 12,007,320.
Application No. 18/215,302 is a continuation of application No. 17/284,083, filed on Apr. 9, 2021, now Pat. No. 11,733,151.
Application No. 17/284,083 is a continuation-in-part of application No. PCT/US19/48678, filed on Aug. 28, 2019.
Application No. PCT/US19/48678 is a continuation-in-part of application No. PCT/US19/46971, filed on Aug. 16, 2019.
(60) Provisional application No. 62/830,311, filed on Apr. 5, 2019.

(51) Int. Cl. G01N 15/1433; G06N 20/00; G06T 7/00; G06T 7/10; G06T 7/40; G06T 7/62

(52) U.S. Cl. CPC G01N 15/1433; G06N 20/00; G06T 7/0012; G06T 7/10; G06T 7/40; G06T 7/62; G06T 2207/10056; G06T 2207/30004; G06T 2207/30024; G06T 2207/30204

(57) ABSTRACT

The present invention is related to, among other things, the devices and methods that improve the accuracy and reliability of an assay, even when the assay device and/or the operation of the assay device has certain errors, and in some embodiments the errors are random.

### CROSS-REFERENCE

This application is a Continuation of U.S. non-Provisional application Ser. No. 18/215,302, filed on Jun. 28, 2023, which is a Continuation of U.S. non-Provisional application Ser. No. 17/284,083, filed on Apr. 9, 2021, which is a National Stage entry (§ 371) application of International Application No. PCT/US2020/026959, filed on Apr. 6, 2020, which claims the benefit of priority of U.S. Provisional Patent Application No. 62/830,311, filed on Apr. 5, 2019, and is a continuation-in-part of International Patent Application No. PCT/US2019/048678, filed on Aug. 28, 2019, which claims the benefit of U.S. Provisional Application Ser. No. 62/742,247, filed on Oct. 5, 2018, and 62/724,025, filed on Aug. 28, 2018; this application is also a continuation-in-part of International Patent Application No. PCT/US2019/046971, filed on Aug. 16, 2019, which claims the benefit of U.S. Provisional Application Ser. Nos. 62/764,886, filed on Aug. 16, 2018, 62/719,129, filed on Aug. 16, 2018, 62/764,887, filed on Aug. 16, 2018, and 62/719,201, filed on Aug. 17, 2019 the contents of which are relied upon and incorporated herein by reference in their entirety. The entire disclosure of any publication or patent document mentioned herein is entirely incorporated by reference.

### FIELD

Among other things, the present invention is related to devices and methods of performing biological and chemical assays, particularly related to an improvement in assay detection accuracy, and reliability when the assays are performed under imperfect conditions with distortions and random variables (e.g., limited resource setting).

### BACKGROUND

In assaying a biomarker in a sample from a subject (e.g., human) for diagnostic a disorder or diseases, the accuracy of the assay is essential. A wrong result can be harmful to the subject. Traditionally, an accuracy of an assay is achieved by a “perfect protocol paradigm”-namely, performing everything, including a sample handling, precisely. Such an approach needs a complex machine, professional operation, ideal environments, etc. to ensure a “perfect” assay device and “perfect” assay performance and operation. However, there are a great need to develop systems and methods that improve the accuracy of an assay that comprising at least one parameter each having an error which can come from the assay device or an operation of the device, and the error can be random depending on a particular device or a particular operation.

### SUMMARY

The present invention is related to, among other things, the devices and methods that improve the accuracy and reliability of an assay, even when the assay device and/or the operation of the assay device has certain errors, and in some embodiments the errors are random.

One aspect of the present invention is to overcome the random errors or imperfections of an assay device or the operation of the assay device by measuring, in addition to measuring the analyte in a sample to generate an analyte test result, the trustworthiness of the analyte test result. The analyte test result will be reported, only when the trustworthiness meets a predetermined threshold, otherwise the analyte test result will be discarded.

In some embodiments, the trustworthy measurement is performed by imaging one or more parameters of the sample being assayed and processing the images using an algorithm.

In some embodiments, one or more monitoring structures (i.e., pillar arrays) are placed on the sample contact area of a sample holder to provide information for the trustworthy measurement.

One aspect of the present invention is to overcome distortion of an optical system in an image-based assay by having a monitoring marks on the sample holder, where one or more optical properties of the monitoring marks for an optical system without a distortion are determined prior an assay testing. The monitoring mark is imaged together with the sample using the optical system with distortion. An algorithm is used to compare the monitoring mark in the optical system with distortion with that without distortion to correct the distortions in image-based assay.

In some embodiments, the algorithm is a machine learning model.

In some embodiments, a method for improving the accuracy of an assay that detects an analyte in a sample, wherein one or more parameters of the assay have a random variation, the method comprising:
detecting, using the assay, the analyte in the sample, generating a detection result;
determining trustworthiness of the detection result by (i) imaging the sample in the assay and (ii) processing the image(s) using an algorithm; and
reporting the detection result, only when the trustworthiness meets a predetermined threshold.

In some embodiments, an apparatus for improving the accuracy of an assay that detects an analyte in a sample, wherein one or more parameters of the assay have a random variation, the apparatus comprising:
an assay that detects the analyte in the sample to generating a detection result, wherein the assay has a sample holder; and
an imager that images the sample in the sample holder; and
a non-transitory storage medium that stores an algorithm that determines, using the images, the trustworthiness of the detection result.

In some embodiments, the method in any prior embodiments further comprising using one or more monitoring marks on a sample holder on the assay and imaging the monitoring marks in the images for determination of the trustworthiness, wherein the monitoring marks have a predetermined optical property in the manufacturing of the sample holder.

In some embodiments, the apparatus in any prior embodiment further comprising one or more monitoring marks on the sample holder, wherein the monitoring marks have a predetermined optical property in the manufacturing of the sample holder and are imaged in the images for determination of the trustworthiness.

In some embodiments, a method for improving the accuracy of an image-based assay that detects an analyte in a sample, wherein the assay has an optical system with a distortion, the method comprising:
having a sample holder having a sample contact surface, wherein (i) a sample forming a thin layer of 200 nm thick or less on the sample contact surface, and (ii) one or more monitoring marks on the sample on the sample contact surface, wherein the monitoring marks have a first set of parameters predetermined during the manufacturing of the sample holder;
using the optical system of the assay to take one or more images of the sample in the sample holder together with the monitoring marks, wherein the monitoring marks having a second set of parameters in the images;
processing the one or more images using a processor, wherein the processor detects distortion of the optical system by using the algorithm and the first set and the second set of the parameters.

In some embodiments, an apparatus for improving the accuracy of an image-based assay that detects an analyte in a sample, wherein the assay has an optical system with a distortion, the apparatus comprising:
a sample holder having a sample contact surface, wherein (i) a sample forming a thin layer of 200 nm thick or less on the sample contact surface, and (ii) one or more monitoring marks on the sample on the sample contact surface, wherein the monitoring marks have a first set of parameters predetermined during the manufacturing of the sample holder;
an optical system of the assay to take one or more images of the sample in the sample holder together with the monitoring marks, wherein the monitoring marks having a second set of parameters in the images;
a processor with a non-transitory storage medium that stores an algorithm that process the one or more images and correct distortion of the optical system by using the algorithm and the first set and the second set of the parameters.

In some embodiments, the method in any prior embodiment, wherein the algorithm is a machine learning model.

In some embodiments, the method in any prior embodiment, wherein the trustworthiness comprising (1) edge of blood, (2) air bubble in the blood, (3) too small blood volume or too much blood volume, (4) blood cells under the spacer, (5) aggregated blood cells, (6) lysed blood cells, (7) over exposure image of the sample, (8) under exposure image of the sample, (8) poor focus of the sample, (9) optical system error as wrong lever position, (10) not closed card, (12) wrong card as card without spacer, (12) dust in the card, (14) oil in the card, (14) dirty out of the focus plane one the card, (15) card not in right position inside the reader, (16) empty card, (17) manufacturing error in the card, (18) wrong card for other application, (19) dried blood, (20) expired card, (21) large variation of distribution of blood cells, (22) none blood sample or (23) none targeted blood sample.

In some embodiments, the method in any prior embodiment, wherein the algorithm is machine learning.

In some embodiments, the method in any prior embodiment, wherein the sample comprises at least one of parameters that has a random variation, wherein the parameter comprises having dusts, air bubble, non-sample materials, or any combination of thereof.

In some embodiments, the method in any prior embodiment, wherein the assay is a cellular assay, immunoassay, nucleic acid assay, colorimetric assay, luminescence assay, or any combination of thereof.

In some embodiments, the method in any prior embodiment, wherein the assay device comprises two plates facing each other with a gap, wherein at least a part of the sample is inside of the gap.

In some embodiments, the method in any prior embodiment, wherein the assay device comprises a QMAX, comprising two plates movable to each other and spacers that regulate the spacing between the plates.

In some embodiments, the method in any prior embodiment, wherein some of the monitoring structures are periodically arranged.

In some embodiments, the method in any prior embodiment, wherein the sample is selected from cells, tissues, bodily fluids, and stool.

The apparatus and the method of any prior embodiment, wherein the sample is amniotic fluid, aqueous humour, vitreous humour, blood (e.g., whole blood, fractionated blood, plasma, serum, etc.), breast milk, cerebrospinal fluid (CSF), cerumen (earwax), chyle, chime, endolymph, perilymph, feces, gastric acid, gastric juice, lymph, mucus (including nasal drainage and phlegm), pericardial fluid, peritoneal fluid, pleural fluid, pus, rheum, saliva, sebum (skin oil), semen, sputum, sweat, synovial fluid, tears, vomit, urine, or exhaled breath condensate.

The apparatus and the method of any prior embodiment, wherein the analyte comprising a molecule (e.g., a protein, peptides, DNA, RNA, nucleic acid, or other molecule), a cell, a tissue, a virus, and a nanoparticle.

The apparatus and the method of any prior embodiment, wherein the samples are the samples that are non-flowable but deformable.

The apparatus and the method of any prior embodiment, wherein the algorithm is machine learning, artificial intelligence, statistical methods, or a combination of thereof.

The apparatus and method of any prior embodiment, wherein the spacers are the monitoring mark, wherein the spacers have a substantially uniform height that is equal to or less than 200 microns, and a fixed inter-spacer-distance (ISD).

The apparatus and method of any prior embodiment, wherein the monitoring mark is used for estimating the TLD (true-lateral-dimension) and true volume estimation.

The apparatus and method of any prior embodiment, wherein step (b) further comprises an image segmentation for an image-based assay.

In some embodiments, the method in any prior embodiment, wherein step (b) further comprises a focus checking in image-based assay.

In some embodiments, the method in any prior embodiment, wherein step (b) further comprises an Evenness of analyte distribution in the sample.

In some embodiments, the method in any prior embodiment, wherein step (b) further comprises an analyze and detection for aggregated analytes in the sample.

In some embodiments, the method in any prior embodiment, wherein step (b) further comprises an analyze for dry-texture in the image of the sample in the sample.

In some embodiments, the method in any prior embodiment, wherein step (b) further comprises an analyze for defects in the sample.

In some embodiments, the method in any prior embodiment, wherein step (b) further comprises a correction of camera parameters and conditions as distortion removal, temperature correction, brightness correction, contrast correction.

### BRIEF DESCRIPTION OF THE DRAWINGS

The skilled artisan will understand that the drawings, described below, are for illustration purposes only. The drawings are not intended to limit the scope of the present teachings in any way. The drawings are not entirely in scale. In the figures that present experimental data points, the lines that connect the data points are for guiding a viewing of the data only and have no other means.

FIG. 1 shows a flow chart of the image-based assay using a special sample holder.

FIG. 2 shows side view and top views of the sample holder, Q-card, with monitoring mark pillars.

FIG. 3 shows the block diagram of with parallel trustworthy risk estimation.

FIG. 4 shows the control flow of imaged-based assay with trustworthy risk estimation.

FIG. 5 shows the flow diagram of true-lateral-dimension correction using a trained machine learning model for pillar detection.

FIG. 6 shows the flow diagram of training a machine learning (ML) model for detecting pillars from the image of the sample.

FIG. 7 shows a diagram showing the relation between training a machine learning model and apply the trained machine learning model in predication (inference)

FIG. 8 shows a diagram of defects, such as dusts, air bubbles, and so forth that can appear in the sample for assaying.

FIG. 9 shows a real image in blood testing with defects in the image of the sample for assaying.

FIG. 10 shows the defects detection and segmentation on the image of the sample using the approach described approach.

FIG. 11 shows a diagram of auto-focus in microscopic photography FIG. 12 shows the diagram of distortion removal with known distortion parameter FIG. 13 shows the diagram of distortion removal and camera adjustment without knowing the distortion parameter

FIG. 14 shows the distorted positions of the monitoring mark pillars in the image of the sample from the distortion of the imager.

### DETAILED DESCRIPTION OF EXEMPLARY EMBODIMENTS

The following detailed description illustrates some embodiments of the invention by way of example and not by way of limitation. The section headings and any subtitles used herein are for organizational purposes only and are not to be construed as limiting the subject matter described in any way. The contents under a section heading and/or subtitle are not limited to the section heading and/or subtitle, but apply to the entire description of the present invention.

The citation of any publication is for its disclosure prior to the filing date and should not be construed as an admission that the present embodiments are not entitled to antedate such publication by virtue of prior invention. Further, the dates of publication provided can be different from the actual publication dates which can need to be independently confirmed.

The terms “trustworthiness”, “error risk”, “error risk factor” and “risk factor” are interchangeable terms to describe a likelihood of a test result being inaccurate. More “trustworthy” means less “likelihood”, (i.e., less a risk) and hence a lower “risk factor”.

The terms “instruction” and “arithmetic” are interchangeable.

The term “imaging-based assay” refers to an assay comprising an imager in detecting an analyte in a sample.

### Improving Assay Accuracy by Checking Trustworthiness of a Test Result

Example of reliability based test reporting to improve the test accuracy. In many assaying situations, there are random variations in an assay's operation, sample handling, and other processes related to an assay operation, and these random variations can affect the assay's test result accuracy.

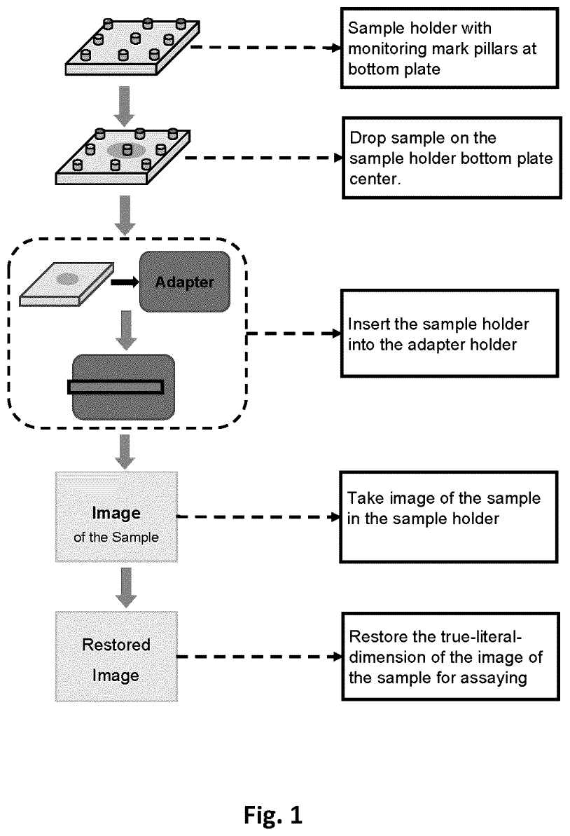

In according to the present invention, monitoring structures for monitoring an assay operation parameter are placed on the sample holder (in some embodiments in the sample area that is being tested). As an example shown in the flowchart in FIG. 1, during a test, both an analyte in a sample and the monitoring structures are measured (either in parallel or sequentially), and from the monitoring structure measurements it determines, through an instruction (a non-transitory storage medium to store the instruction), to determine a trustworthy of the analyte measurement. If the trustworthy is higher than a threshold (i.e. a risk factor is lower than a threshold), the analyte measurement result will be reported, otherwise the analyte measurement result will not be reported.

If an analyte measurement result is not reported due to a poor trustworthy (higher than a threshold, optionally, a second sample and/or second test will be tested in the same manner as that in the first. Should the second sample and/or test still has a poor trustworthy, the third sample and/or test will be performed. The process can be continued until a trustworthy analyte measurement result is reported.

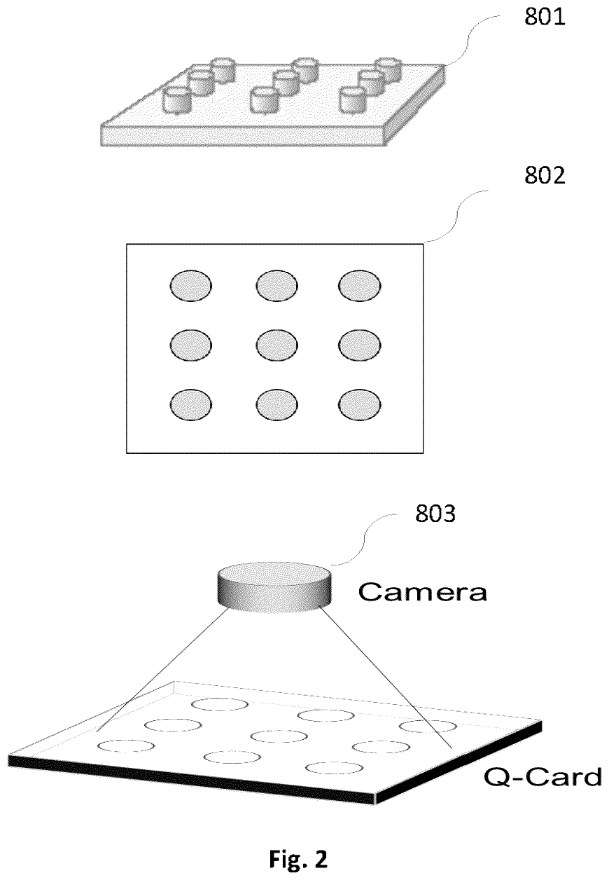

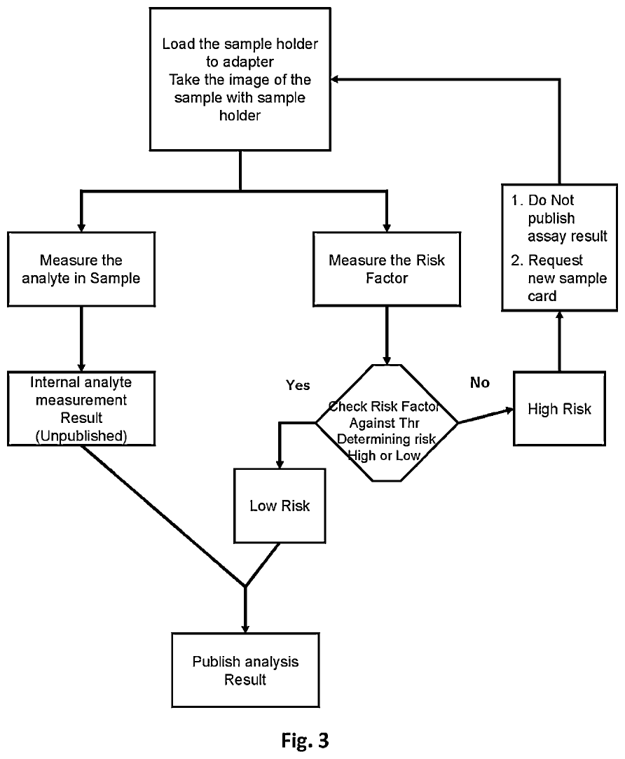

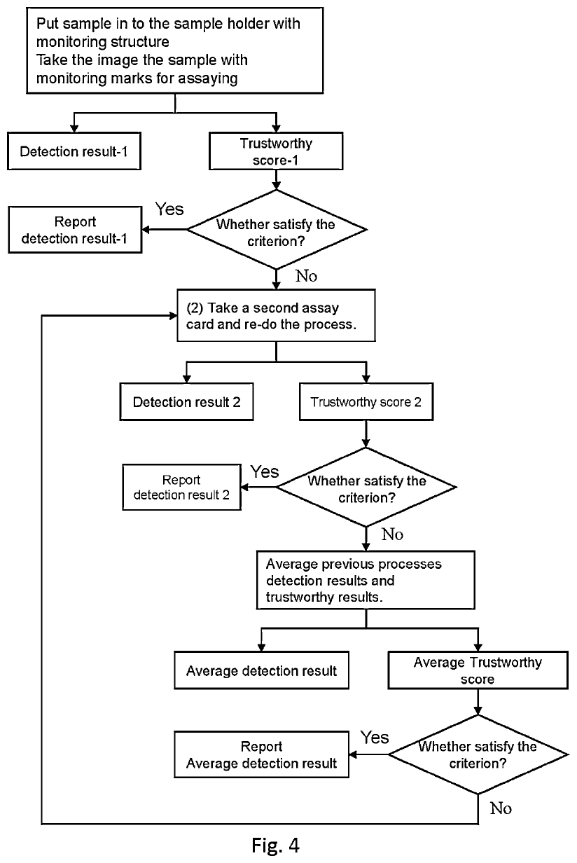

Examples of monitoring structures include, but are not limited to the spacers, scale marks, imaging marks, and location marks on a Q-Card (i.e., QMAX Card). FIG. 2 is a diagram of the sample holder Q-card. The monitoring parameters include, but not limited to, images of the monitoring structures, light transmission, light scattering, color (wavelength spectrum), polarization, etc. The monitoring parameter also include the sample images on the Q-Card. The instruction of determining trustworthy or not can be pertained by performing tests under various conditions that are deviate from an ideal one. In some embodiments, machine learning is used to learn how to determine a threshold of a trustworthy.

In some embodiments, the monitoring parameters are related to the sample holders operation and conditions, sample conditions, or reagent condition, or measurement instrument conditions.

A method for improve test result accuracy of an assay, the method comprising:
having a sample holder with a monitoring mark;
having a sample on the sample holder, wherein the sample is suspected to contain or contains an analyte;
measuring the analyte to generate an analyte measurement result (i.e. test result), and measuring the monitoring mark to generate a monitoring parameter, either in parallel or in sequential;
determining, using an instruction and the monitoring parameter, a trustworthy of the analyte measuring result;
determining a publishing of the analyte measuring result.

FIG. 3 shows a diagram of assaying with the trustworthy checking, and in some embodiments, the analyte measuring results published only when the trustworthy is high (the risk factor is low). In some embodiments, when the trustworthy is low, the analyte measuring result will not be published. In some embodiments, when the trustworthy is low, the analyte measuring result of a fires sample will not be published and a second sample will be used to go through the same process as described above. In some embodiments, the process are repeated until a high trustworthy analyte measurement result is achieved.

The device for improving test accuracy by measuring the monitoring parameters, comprising: sample cards with monitoring structures, imagers, and a media that stores an instruction for determining the trustworthiness of a test result.

Examples for Methods and Apparatus of Mobile Assaying (with QMAX Card)—Concentration Estimation (CBC), Segmentation, Etc. With Image Processing and Machine Learning.
AA-1. A method for correcting a system error of an image system containing a thin-layer sample, the method comprising:
receiving, by a processing device of the image system, an image and first parameters associated with a sample card comprising a sample and a monitor standard;
determine, by the processing device using a first machine learning model, the system error of the image system by comparing the first parameters with second parameters associated with the monitor standard determined during manufacture of the sample card;
correcting, by the processing device, the image of the sample card taking into account the system error; and
   determining, by the processing device using the corrected image, a biological property of the sample.
   AA-2. The method of Example AA-1, wherein the monitor standard comprises a plurality of nanostructures on a plate of the sample card, and wherein the sample is deposited on the plate.
   AA-3. The method of Example AA-1, wherein the sample is a biological sample collected from an animal.

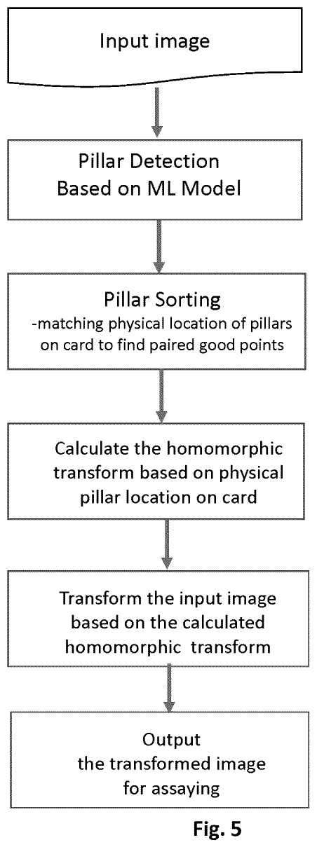

FIG. 5 shows a flow chart for true-lateral-dimension (TLD) estimation with pillars and using markers (pillars) to do image correction from the imaging of Q-card

BA-1. An intelligent assay monitor method, comprising:
receiving, by a processing device, an image encoding first information of a biological sample deposited in a sample card and second information of a plurality of monitor marks;
determining, by the processing device executing a first machine learning model on the image, a measurement of a geometric feature associated with the plurality of monitor marks;
determining, by the processing device, a variation between the measurement of the geometric feature with a ground truth value of the geometric feature provided with the sample card;
correcting, by the processing device based on the variation, the image encoding the first information and the second information; and
determining, by the processing device using the corrected image, a biological property of the biological sample.
   BA-2. The method of Example BA-1, wherein the sample card comprises a first plate, a plurality of pillars that are substantially perpendicularly integrated to a surface of the first plate, and a second plate capable of enclosing the first plate to form a thin layer in which the biological sample is deposited.

BA-3. The method of Example BA-2, wherein the plurality of monitor marks corresponds to the plurality of pillars.

BA-4. The method of Example BA-3, wherein at least two of the plurality of pillars are separated by a true-lateral-dimension (TLD), and wherein determining, by the processing device executing a first machine learning model on the image, a measurement of a geometric feature associated with the plurality of monitor marks comprises determining, by the processing device executing the first machine learning model on the image, the TLD.

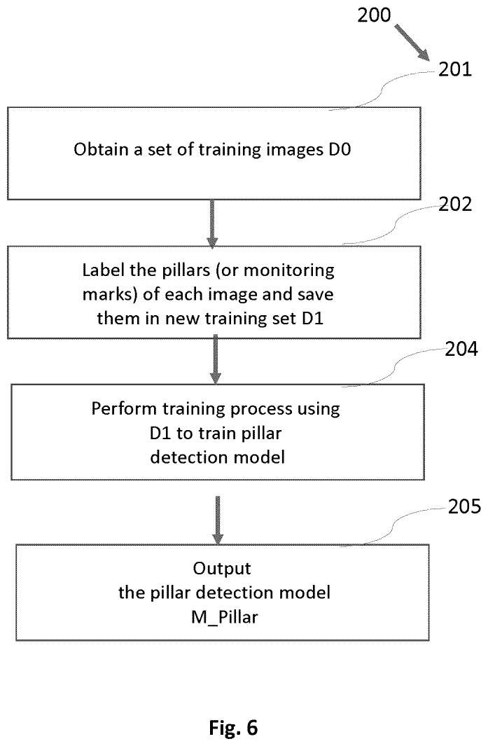

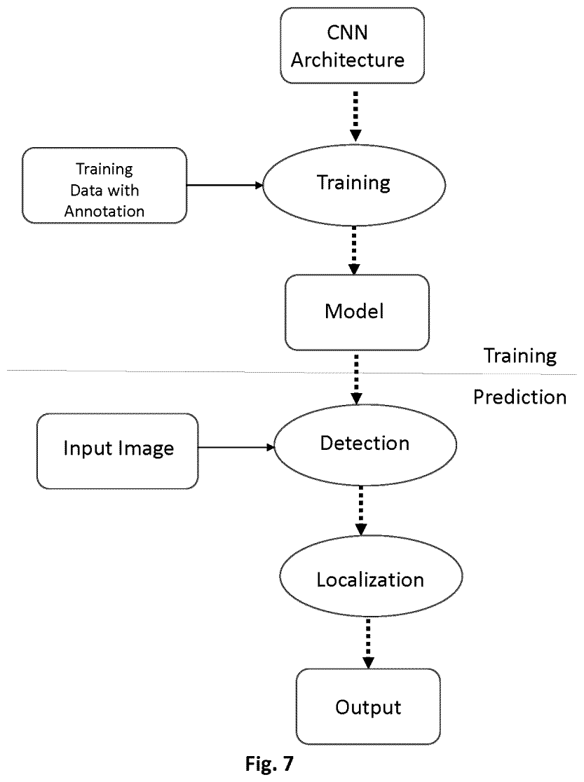

FIG. 6 shows the flow diagram of training a machine learning model for pillar detection in TLD correction using monitoring mark pillars. FIG. 7 shows the relation between training a machine learning model and applying the trained machine learning model in predication (inference)

BB-1 An image system, comprising:
a sample card comprising a first plate, a plurality of pillars substantially perpendicularly integrated to a surface of the first plate, and a second plate capable of enclosing the first plate to form a thin layer in which the biological sample is deposited;
a computing device comprising:
a processing device, communicatively coupled to an optical sensor, to:
receive, from the optical sensor, an image encoding first information of a biological sample deposited in the sample card and second information of a plurality of monitor marks;
determine, using a first machine learning model on the image, a measurement of a geometric feature associated with the plurality of monitor marks;
determine a variation between the measurement of the geometric feature with a ground truth value of the geometric feature provided with the sample card;
correct, based on the variation, the image encoding the first information and the second information; and
determine, based on the corrected image, a biological property of the biological sample.

### Detection of Objects on Pillars for Improper Closing Detection of the Card in Assaying

CA-1. A method for correcting human operation errors recorded in an assay image of a thin-layer sample, the method comprising:
receiving, by a processing device of an image system, an image of a sample card comprising a sample and a monitor standard, wherein the monitor standard comprises a plurality of nanostructures integrated on a first plate of the sample card, and wherein the sample is deposited on the first plate in an open configuration of the sample card and is enclosed by a second plate of the sample card in a close configuration of the sample card;
segmenting, by the processing device, the image into first sub-regions corresponding to the sample and second sub-regions corresponding to the plurality of nanostructures;
comparing, by the processing device, the second sub-regions with the monitor standard provided during manufacture of the sample to determine whether at least one of the second sub-regions contains a foreign object other than the nanostructures;
responsive to determining that at least one of the second sub-regions contains a foreign object other than the nanostructures, determining an error associated with operating the sample card; and
correcting the image of the sample card by removing the at least one sub-region from the image.
   CA-2. The method of Example CA-1, wherein the foreign object is one of a portion of the sample, an air bubble, or an impurity.

### Examples for Defects (e.g., Air Bobble, Dust, Etc.) and Auxiliary Structure (e.g., Pillars) Removal in Assaying

DA-1. A method for measuring a volume of a sample in a thin-layered sample card, the method comprising:
receiving, by a processing device of an image system, an image of a sample card comprising a sample and a monitor standard, wherein the monitor standard comprises a plurality of pillars perpendicularly integrated to a first plate of the sample, and each of the plurality of pillars has a substantially identical height (H);
determining, by the processing device using a machine learning model, a plurality of non-sample sub-regions, wherein the plurality of non-sample sub-regions correspond to at least one of a pillar, an air bubble, or an impurity element;
calculating, by the processing device, an area occupied by the sample by removing the plurality of non-sample sub-regions from the image;
calculating, by the processing device, a volume of the sample based on the calculated area and the height (H) and
   determining, by the processing device based on the volume, a biological property of the sample.

### Examples of Determining the Trustworthy of the Assay Results

a. Shape segmentation combining ML based bounding box detection and image processing-based shape determination
b. Evenness of analyte detection in assaying (IQR based outlier detection)
c. Aggregated analytes detection using ML
d. Dry texture on the card detection using ML
e. Defects, e.g. dust, oil, etc. detection using ML
f. Air bubble detection using ML
   EA-1. A method for determining a trustworthy of measurement associated with an image assay result, the method comprising:
receiving, by a processing device of an image system, an image of a sample card comprising a sample and a monitor standard comprising a plurality of nanostructures integrated to a first plate of the sample;
segmenting, by the processing device, the image into first sub-regions corresponding to the sample and second sub-regions corresponding to the plurality of nanostructures;
determining, by the processing device using a first machine learning model, non-compliant elements in at least one of the first sub-regions or the second sub-regions;
determining, by the processing device based on the first sub-regions and the second sub-regions, a biological property of the sample;
calculating, by the processing device based on a statistical analysis of the non-compliant elements, the trustworthy measurement associated with the biological property; and
determining, by the processing device based on the trustworthy measurement, a further action to the sample.
   EA-2. The method of Example EA-1, further comprising:
determining, by the processing device based on the trustworthy measurement, that the biological property is reliable; and
providing, by the processing device, the biological property to a display device.
   EA-3. The method of Example EA-1, further comprising:
determining, by the processing device based on the trustworthy measurement, that the biological property is less than reliable; and
providing, by the processing device, the biological property and the corresponding trustworthy measurement to a display device to allow a user to determine whether to accept or discard the biological property.
   EA-4. The method of Example EA-1, wherein segmenting, by the processing device, the image into first sub-regions corresponding to the sample and second sub-regions corresponding to the plurality of nanostructures:
performing, by the processing device using an image processing method, a first image segmentation on the image to generate a first segmentation result;
performing, by the processing device using a second machine learning model, a second image segmentation on the image to generate a second segmentation result; and
combining, by the processing device, the first segmentation result and the second segmentation result to segment the image into the first sub-regions corresponding to the sample and the second sub-regions corresponding to the plurality of nanostructures.
   EA-5. The method of Example EA-1, wherein determining, by the processing device using a first machine learning model, non-compliant elements in at least one of the first sub-regions or the second sub-regions comprises: at least one of
determining, by the processing device, the non-compliance elements based on a distribution unevenness of at least one analyte in the sample;
determining, by the processing device, the non-compliance elements based on aggregated analyte detection of the sample;
determining, by the processing device, the non-compliance elements based on detection of dry texture in the sample;
determining, by the processing device, the non-compliance elements based on detection of impurities in the sample; or
determining, by the processing device, the non-compliance elements based on detection of air bubbles in the sample.
   Multi-Segmented Testing on a Single Card with Content Based on Segmentation
   FA-1. A method for determining measurements of multiple analytes using a single sample card, the method comprising:
receiving, by a processing device of an image system, an image of a sample card comprising a sample and a monitor standard, wherein the monitor standard comprises a plurality of nanostructures integrated to a first plate of the sample;
segmenting, by the processing device using a first machine learning model, the image into first sub-regions associated with a first analyte contained in the sample, second regions associated with a second analytes contained in the sample, and third sub-regions corresponding to the plurality of nanostructures;
determining, by the processing device based on the third sub-regions corresponding to the plurality of nanostructures, a true lateral distance (TLD) between two adjacent nanostructures;
determining, by the processing device based on the TLD, a first accumulative area of the first sub-regions and further determining a first volume based on the first accumulative area and a height associated with the plurality of nanostructures;
determining, by the processing device based on the TLD, a second accumulative area of the sub-regions and further determining a second volume based on the second accumulative area and the height associated with the plurality of nanostructures;
determining, by the processing device based on a count of the first analyte in the first volume, a first measurement of the first analytes; and
determining, by the processing device based on a count of the second analyte in the second volume, a second measurement of the second analytes.

### System and Apparatus of Pillar-Based Spectrophotometer

GA-1. A method for measuring a biological property of a sample provided in a sample card comprising a plurality of nano-pillars, the method comprising:
receiving, by a processing device of an image system, an image of a sample card comprising a sample and a monitor standard comprising a plurality of nanostructures integrated to a first plate of the sample;
segmenting, by the processing device, the image into first sub-regions corresponding to the sample and second sub-regions corresponding to the plurality of nano-pillars;
determining, by the processing device, a first spectrophotometric measurement of the first sub-regions;
determining, by the processing device, a second spectrophotometric measurement of the second sub-regions; and
determining, by the processing device based on a ratio between the first spectrophotometric measurement and a second spectrophotometric measure, a biological property of the sample.
   GA-2. A method of analyzing the compound concentration using the measured response of the compound at a specific wavelength of light or at multiple wavelength of light, the method comprising:
receiving, by a processing device of an image system, an image or multiple images taken on a sample card with a specific or multiple wavelength of light, wherein the sample card comprising a sample and a monitor standard comprising a plurality of nanostructures integrated to a first plate of the sample;
segmenting, by the processing device, each image into first sub-regions corresponding to the sample and second sub-regions corresponding to the plurality of nano-pillars;
determining, from the images of the sample taken at different wavelength, the light absorptions at the first sub-regions from the sample;
determining, from the images of the sample taken at different wavelength, the light absorptions at the second sub-regions from the nano-pillars; and
determining the compound concentration from the light absorption measurements of these two sub-regions at one or multiple wavelength.

Moreover, in some embodiments of the present invention, the detection and segmentation of each image into first sub-regions corresponding to the sample and the second sub-regions corresponding to the plurality of nano-pillars is based on a machine learning model trained on the training image samples with labeled nano-pillars.

### Labeling Large Amount of Small and Repeated Objects

HA-1. A method for labeling a plurality of objects in an image for preparing a training data, the method comprising:
receiving, by a processing device, the image in a graphic user interface;
receiving, by the processing device through the graphic user interface, a selection of a position in the image;
calculating, by the processing device based on a plurality of pixels local to the position, a bounding box surrounding the position;
providing, by the processing device, a display of the bounding box superposed on the image in the graphic user interface; and
responsive to receiving a user confirmation, labeling a region within the bounding box as a training data.
   IA-1. A method for preparing an assay image, the method comprising:
providing a sample card comprising a plurality of marker elements;
   depositing a sample on a first plate of the sample card in an open configuration;
   closing the sample card to press a second plate of the sample card against the first plate to a close configuration, where the first plate and the second plate in the close configuration form a thin layer comprising a substantially uniform thickness of the sample and the plurality of marker elements; and
providing an image system comprising a processing device and a non-transitory storage medium to store instructions that, when executed by the processing device, are to:
capture an image of the sample card comprising the substantially uniform thickness of the sample and the plurality of marker elements;
detect the plurality of marker elements in the image;
compare the detected plurality of marker elements with a monitor standard associated with the sample card to determine a geometric mapping between the plurality of marker elements and the monitor standard;
   determine a non-ideal factor of the image system based on the geometric mapping; and
   process the image of the sample card to correct the non-ideal factor.
   IB-1. A method for preparing an assay image, the method comprising:
   providing a sample card comprising a plurality of marker elements;
   depositing a sample on a first plate of the sample card in an open configuration;
   closing the sample card to press a second plate of the sample card against the first plate to a close configuration, where the first plate and the second plate in the close configuration form a thin layer comprising a substantially uniform thickness of the sample and the plurality of marker elements; and
providing an image system comprising a processing device and a non-transitory storage medium to store instructions that, when executed by the processing device, are to:
   capture an image of the sample card comprising the substantially uniform thickness of the sample and the plurality of marker elements;
   partition the image into a plurality of sub-regions;
   determine, using a machine learning model and the plurality of marker elements, whether each of the plurality of sub-regions meets a requirement of the image system;
   responsive to determining that a sub-region fails to meet the requirement, label the first sub-region as non-compliant;
   responsive to determining that the sub-region meets the requirement, label the first sub-region as compliant; and
   perform an assay analysis using the compliant sub-regions of the image.
   IC-1. A method for correcting a non-ideal factor of an image system, the method comprising:
receiving, by a processing device of the image system, an image of a sample card comprising a substantially uniform layer of a sample deposited on a plate of the sample card and the plurality of marker elements associated with the sample card;
detecting, by the processing device, the plurality of marker elements in the image;
comparing the detected plurality of marker elements with a monitor standard associated with the sample card to determine a geometric mapping between the plurality of marker elements and the monitor standard;
determining the non-ideal factor of the image system based on the geometric mapping; and
processing the image of the sample card to correct the non-ideal factor.
   ID-1. A method for correcting a non-ideal factor of an image system, the method comprising:
receiving, by a processing device of the image system, an image of a sample card comprising a substantially uniform layer of a sample deposited on a plate of the sample card and the plurality of marker elements associated with the sample card;
partitioning, by the processing device, the image into a plurality of sub-regions;
determining, by the processing device using a machine learning model and the plurality of marker elements, whether each of the plurality of sub-regions meets a requirement of the image system;
responsive to determining that a sub-region fails to meet the requirement, labeling, by the processing device, the first sub-region as non-compliant;
responsive to determining that the sub-region meets the requirement, labeling, by the processing device, the first sub-region as compliant; and
performing, by the processing device, an assay analysis using the compliant sub-regions of the image.
   IE-1. An image system, comprising:
an adapter to hold a sample card comprising a first plate, a second plate, and a plurality of marker elements;
a mobile computing device coupled to the adapter, the mobile computing device comprising:
an optical sensor to capture an image of the plurality of marker elements and the sample card comprising a substantially uniform layer of a sample deposited between the first plate and the second plate of the sample card;
a processing device, communicatively coupled to the optical sensor, to:
receive the image captured by the optical sensor;
detect the plurality of marker elements in the image;
compare the detected plurality of marker elements with a monitor standard associated with the sample card to determine a geometric mapping between the plurality of marker elements and the monitor standard;
determine a non-ideal factor of the image system based on the geometric mapping; and
process the image of the sample card to correct the non-ideal factor.
   IF-1. An image system, comprising:
an adapter to hold a sample card comprising a first plate, a second plate, and a plurality of marker elements;
a mobile computing device coupled to the adapter, the mobile computing device comprising:
an optical sensor to capture an image of the plurality of marker elements and the sample card comprising a substantially uniform layer of a sample deposited between the first plate and the second plate of the sample card;
a processing device, communicatively coupled to the optical sensor, to:
   receive the image captured by the optical sensor;
   partition the image into a plurality of sub-regions;
   determine, using a machine learning model and the plurality of marker elements, whether each of the plurality of sub-regions meets a requirement of the image system;
   responsive to determining that a sub-region fails to meet the requirement, label the first sub-region as non-compliant;
   responsive to determining that the sub-region meets the requirement, label the first sub-region as compliant; and
   perform an assay analysis using the compliant sub-regions of the image.
   IG-1. A mobile imaging device, comprising:
an optical sensor; and
a processing device, communicatively coupled to the optical sensor, to:
receive the image captured by the optical sensor, the image comprising a plurality of marker elements and a substantially uniform layer of a sample deposited between a first plate and a second plate of a sample card;
detect the plurality of marker elements in the image;
compare the detected plurality of marker elements with a monitor standard associated with the sample card to determine a geometric mapping between the plurality of marker elements and the monitor standard;
determine a non-ideal factor of the image system based on the geometric mapping; and
process the image of the sample card to correct the non-ideal factor.)
   IH-1. A mobile imaging device, comprising:
an optical sensor; and
a processing device, communicatively coupled to the optical sensor, to:
receive the image captured by the optical sensor, the image comprising a plurality of marker elements and a substantially uniform layer of a sample deposited between a first plate and a second plate of a sample card;
   partition the image into a plurality of sub-regions;
   determine, using a machine learning model and the plurality of marker elements, whether each of the plurality of sub-regions meets a requirement of the image system;
   responsive to determining that a sub-region fails to meet the requirement, label the first sub-region as non-compliant;
   responsive to determining that the sub-region meets the requirement, label the first sub-region as compliant; and
   perform an assay analysis using the compliant sub-regions of the image.
   II-1. An intelligent assay monitor method, comprising:
receiving, by a processing device, an image encoding first information of a biological sample deposited in a sample card and second information of a plurality of monitor marks;
determining, by the processing device executing a first machine learning model on the image, a measurement of a geometric feature associated with the plurality of monitor marks;
determining, by the processing device, a variation between the measurement of the geometric feature with a ground truth value of the geometric feature provided with the sample card;
correcting, by the processing device based on the variation, the image encoding the first information and the second information; and
determining, by the processing device using the corrected image, a biological property of the biological sample.
   II-2. The method of Example II-1, wherein the sample card comprises a first plate, a plurality of pillars that are substantially perpendicularly integrated to a surface of the first plate, and a second plate capable of enclosing the first plate to form a thin layer in which the biological sample is deposited.
   II-3. The method of Aspect II-2, wherein the plurality of monitor marks corresponds to the plurality of pillars.
   II-4. The method of Aspect II-2, wherein the plurality of monitor marks are provided in at least one of the first plate or the second plate.
   II-5. The method of II-1, wherein determining, by the processing device executing a first machine learning model on the image, the measurement of the geometric feature associated with the plurality of monitor marks further comprises:
identifying, by the processing device executing a first machine learning model the plurality of monitor marks from the image; and
determining, by the processing device based on the identified plurality of monitor marks, the measurement of the geometric feature.
   II-6. The method of Aspect II-1, wherein determining, by the processing device, the variation between the measurement of the geometric feature with a ground truth value of the geometric feature provided with the sample card further comprises:
determining, by the processing device, one of a system error or a human operator error; and
presenting the determined one of the system error or the human operator error on a display device associated with the processing device.
   II-7. An image system, comprising:
a sample card comprising a first plate, a plurality of pillars substantially perpendicularly integrated to a surface of the first plate, and a second plate capable of enclosing the first plate to form a thin layer in which the biological sample is deposited;
a computing device comprising:
a processing device, communicatively coupled to an optical sensor, to:
receive, from the optical sensor, an image encoding first information of a biological sample deposited in the sample card and second information of a plurality of monitor marks;
determine, using a first machine learning model on the image, a measurement of a geometric feature associated with the plurality of monitor marks;
determine a variation between the measurement of the geometric feature with a ground truth value of the geometric feature provided with the sample card;
correct, based on the variation, the image encoding the first information and the second information; and
determine, based on the corrected image, a biological property of the biological sample.
   IJ-1. A method for correcting non-ideal factors in an assay image of a thin-layer sample, the method comprising:
providing a sample card comprising a monitor standard which comprises a plurality of nanostructures on a plate of the sample card;
depositing a sample on the plate of the sample card; and
providing an image system comprising a processing device and a non-transitory storage media to store instructions that, when executed by the processing device, are to:
capture an image of the sample card comprising the sample and the monitor standard;
determine a non-ideal factor of the image system by comparing the image of the sample card with a plurality of geometric values of the monitor standard determined during manufacture of the sample card; and correct the image of the sample card taking into account the non-ideal factor.
   IJ-2. A method for correcting non-ideal factors in an assay image of a thin-layer sample, the method comprising:
receiving, by a processing device of an image system, an image of a sample card comprising a sample and a monitor standard, wherein the monitor standard comprises a plurality of nanostructures on a plate of the sample card, and wherein the sample is deposited on the plate;
determining, by the processing device, a non-ideal factor of the image system by comparing the image of the sample card with a plurality of geometric values of the monitor standard determined during manufacture of the sample card; and
correcting the image of the sample card taking into account the non-ideal factor.
   IJ-3. A method for correcting non-ideal factors in an assay image of a thin-layer sample, the method comprising:
receiving, by a processing device of an image system, an image of a sample card comprising a sample and a monitor standard, wherein the monitor standard comprises a plurality of nanostructures on a plate of the sample card, and wherein the sample is deposited on the plate;
determining, by the processing device using a machine learning model, a non-ideal factor of the image system, wherein the machine learning model is trained by comparing images of the sample card with geometric values of the monitor standard determined during manufacture of the sample card; and
correcting the image of the sample card taking into account the non-ideal factor.
   IJ-4. A mobile imaging device, comprising:
an optical sensor; and
a processing device, communicatively coupled to the optical sensor, to:
receive an image of a sample card comprising a sample and a monitor standard, wherein the monitor standard comprises a plurality of nanostructures on a plate of the sample card, and wherein the sample is deposited on the plate;
determine a non-ideal factor of the mobile imaging system by comparing the image of the sample card with a plurality of geometric values of the monitor standard determined during manufacture of the sample card; and
correct the image of the sample card taking into account the non-ideal factor.
   IJ-5. An image system, comprising:
an adapter to hold a sample card comprising a monitor standard, wherein the monitor standard comprises a plurality of nanostructures on a plate of the sample card, and wherein a sample is deposited on the plate;
a mobile computing device coupled to the adapter, the mobile device comprising:
an optical sensor; and
a processing device, communicatively coupled to the optical sensor, to:
receive an image of the sample card;
determine a non-ideal factor of the image system by comparing the image of the sample card containing a sample deposited on the plate with a plurality of geometric values of the monitor standard determined during manufacture of the sample card; and correct the image of the sample card taking into account the non-ideal factor.
   IJ-6. A sample card, comprising:
a monitor standard which comprises a plurality of nanostructures on a plate of the sample card, wherein a sample is deposited on the plate, and wherein the sample card is plugged into an adapter coupled to an image system comprising a processing device and an optical sensor to capture an image of the sample card, the processing device to:
receive the image of the sample card;
determine a non-ideal factor of the image system by comparing the image of the sample card containing a sample deposited on the plate with a plurality of geometric values of the monitor standard determined during manufacture of the sample card; and correct the image of the sample card taking into account the non-ideal factor.
   IJ-7. A method for correcting a system error of an image system containing a thin-layer sample, the method comprising:
receiving, by a processing device of the image system, an image and first parameters associated with a sample card comprising a sample and a monitor standard, wherein the monitor standard comprises a plurality of nanostructures on a plate of the sample card, and wherein the sample is deposited on the plate;
determine, by the processing device, the system error of the image system by comparing the first parameters with second parameters associated with the monitor standard determined during manufacture of the sample card; and
correcting the image of the sample card taking into account the system error.
   IJ-8. A method for correcting human operation errors recorded in an assay image of a thin-layer sample, the method comprising:
receiving, by a processing device of an image system, an image of a sample card comprising a sample and a monitor standard, wherein the monitor standard comprises a plurality of nanostructures on a plate of the sample card, and wherein the sample is deposited on the plate;
determining, by the processing device using a machine learning model, a human operation error reflected in the image by comparing the image of the sample card with a plurality of geometric values of the monitor standard determined during manufacture of the sample card, wherein the human operation error comprises mis-handling of the image system; and
correcting the image of the sample card by removing the human operation error reflected in the image.

### Assay Device Operation Error Monitoring and Correction

A method of monitoring and correcting the errors occurred in operating an assay device, comprising:
(a) having a Q-CARD with monitoring marks on the plate (inside of the sample);
(b) performing the sample deposition,
(c) imaging using an imager, during the measurements, the monitoring marks;
(d) determining operation errors by comparing the images of the monitoring mark with the ideal image of the monitoring mark;
   wherein the ideal image of the monitoring mark is the image of the monitoring mark when an operation is performed correctly;
   wherein the monitoring mark is prefabricated.

A method of monitoring an imperfection in operating an assay device, comprising:
(a) having a Q-CARD with monitoring marks on the plate (inside of the sample);
(b) performing the sample deposition,
(c) imaging using an imager, during the measurements, the monitoring marks;
(d) determining operation errors by comparing the images of the monitoring mark with the ideal image of the monitoring mark;
   wherein the ideal image of the monitoring mark is the image of the monitoring mark when an operation is performed correctly;
wherein the monitoring mark is prefabricated.
   OA-1 In some embodiments of the present invention, a method for improving accuracy of an assay that has one or more operation conditions unpredictable and random, comprising:
(a) detecting an analyte in a sample that contains or is suspected of containing the analyte, comprising:
   (i) having the sample into a detection instrument, and
   (ii) using the detection instrument to measure the sample to detect the analyte, generating a detection result of the detection;
(b) determining trustworthiness of the detection result in step (a), comprising:
   (i) taking one or more images of (1) a portion of the sample and/or (2) a portion of the detection instrument that is surrounded the portion of the sample, wherein the images substantially represent the conditions that the portion of the sample is measured in generating detection result in step (a); and
   (ii) using a computational device with an algorithm to analyze the images taken in step (b) (i) to determine a trustworthiness of the detection result in step (a); and
(c) reporting both the detection result and the trustworthiness;
wherein the step (a) has one or more operation conditions that is unpredictable and random.

In certain embodiments, the method OA-1 further comprises a step of discarding the detection result generated in step (a), if the worthiness determined in the step (b) is below a threshold.

In certain embodiments, the method OA-1 further comprises a step of revising the detection result generated in step (a), if the worthiness determined in the step (b) is below a threshold.

OA-2. An apparatus for improving accuracy of an assay that has one or more operation conditions unpredictable and random, comprising:
(1) a detection device that detects an analyte in a sample to generate a detection result, wherein the sample contains or is suspected of containing the analyte;
(2) a checking device that checks trustworthiness of a particular detection result generated by the detection device, comprising:
   (i) an imager that is capable of taking one or more images of (1) a portion of the sample and/or (2) a portion of the detection instrument that is surrounded the portion of the sample, wherein the images substantially represent the conditions that the portion of the sample is measured in generating detection result in step (a); and
   (ii) a computing unit with an algorithm that is capable of analyzing the features in the images taken in step (b) (i) to determine a trustworthiness of the detection result;
(c) discarding the detection result generated in step (a), if the step (b) determines the detection result is untrustworthy;
wherein the step (a) has one or more operation conditions that is unpredictable and random.

In certain embodiments, the algorithm in OA-1 is machine learning, artificial intelligence, statistical methods, etc. OR a combination of thereof.

The term “operation conditions” in performing an assay refers to the conditions under which an assay is performed. The operation conditions include, but not limited to, at least three classes: (1) defects related to sample, (2) defects related to the sample holder, and (3) defects related to measurement process. The term “defects” means deviate from an ideal condition.

The examples of the defects related to the samples include, but limited to, the air bubble in a sample, the dust in a sample, the foreign objects (i.e. the objects that are not from the original sample, but comes into the sample later), the dry-texture in a sample where certain part of the sample dried out, insufficient amount of sample, the incorrect sample, no sample, samples with incorrect matrix (e.g. blood, saliva), the incorrect reaction of reagents with the sample, the incorrect detection range of the sample, the incorrect signal uniformity of the sample, the incorrect distribution of the sample, the incorrect sample position with the sample holder (e.g. blood cells under spacer), etc.

The examples of the defects related to the sample holder include, but limited to, missing spacers in sample holders, the sample holder is not closed properly, the sample hold is damaged, and the sample holder surface become contaminated, the reagents on the sample was not properly prepared, the sample holder in an improper position, the sample holder with incorrect spacer height, large surface roughness, incorrect transparence, incorrect absorptance, no sample holders, incorrect optical properties of sample holder, incorrect electrical properties of sample holder, incorrect geometry (size, thickness) of sample holder, etc.

The examples of the defects related to the measurement process include, but limited to, the light intensity, the camera conditions, the sample not in focus in the image taken by the imager, the temperature of light, the color of light, the leakage of environment light, the distribution of light, the lens conditions, the filter conditions, the optical components conditions, the electrical components conditions, the assembling conditions of instruments, the relative position of sample, sample holder and instrument, etc.

### A. A Thin Layer Sample on a Solid Phase.

A1. A method for assaying a sample with one or more operation conditions random and unpredictable, comprising:
(a) providing a sample that contains or is suspected of containing an analyte;
(b) depositing the sample onto a solid surface;
(c) measuring, after step (b), the sample to detect the analyte and generate a result of the detection, wherein the result can be effected by one more operation conditions in performing the assaying, and wherein the operation conditions are random and unpredictable;
(d) imaging a portion of the sample area/volume where the analyte in the sample is measured in step (c); and
(e) determining the error-risk-probability of the result measured in step (c) by analyzing the one or more operation conditions shown in one or more images generated in step (d).

Furthermore, if step (e) determines that the result measured in step (c) has a high error risk probability, the result will be discarded.

AD1. A device for assaying an analyte present in a sample under one or more operational variables, comprising:
(a) a solid surface having a sample contact area for receiving a thin layer of a sample, the sample containing an analyte to be measured;
(b) an imager configured to image a portion of the sample contact area where the analyte is measured; and
(c) a non-transitory computer readable medium having an instruction that, when executed, it performs the determination of trustworthy of the assay result by analyzing the operational variables displayed in the image of the portion of the sample.

### B. A Thin Layer Sample Between Two Plates

B1. A method for assaying a sample with one or more operational variables, comprising:
(a) depositing a sample containing an analyte between a first plate and a second plate; wherein the sample is sandwiched between the first plate and the second plate which are substantially in parallel;
(b) measuring the analyte contained in the sample to generate a result, wherein the measuring involving one more operational variables that are random and unpredictable;
(c) imaging an area portion of the first plate and the second plate to generate an image, where the area portion contains the sample and the analyte contained in the sample is measured; and
(d) determining if the result measured in step (b) is trustworthy by analyzing the operational variables shown in the image of the area portion containing the sample.

Furthermore, if the analysis in step (d) determines that the result measured in step (b) is not trustworthy, the result is discarded.

C. A Thin Layer Sample Between Two Plates with Spacer
C1. A method for assaying a sample with one or more operational variables, comprising:
(a) depositing a sample that contains or suspected to contain an analyte between a first plate and a second plate, wherein the sample is sandwiched between the first plate and the second plate that are movable relative to each other into a first configuration or a second configuration;
(b) measuring the analyte in the sample to generate a result, wherein the measuring involving one more operational variables that are random and unpredictable; and
(c) imaging an area portion of the sample where the analyte is measured; and
(d) determining if the result measured in step (b) is trustworthy by analyzing the operational variables shown in the image of the area portion,
wherein the first configurations is an open configuration, in which the two plates are partially or completely separated apart, the spacing between the plates is not regulated by the spacers, and the sample is deposited on one or both of the plates, and
wherein the second configurations is a closed configuration which is configured after the sample is deposited in the open configuration and the plates are forced to the closed configuration by applying the imprecise pressing force on the force area; and in the closed configuration: at least part of the sample is compressed by the two plates into a layer of highly uniform thickness and is substantially stagnant relative to the plates, wherein the uniform thickness of the layer is confined by the sample contact areas of the two plates and is regulated by the plates and the spacers.

Furthermore, if step (d) determines that the result measured in step (b) is not trustworthy, the result is discarded.

D. Reliability Check in all Devices that are Described
D1. A method for assaying a sample with one or more operational variables, comprising:
(a) depositing a sample that contains or is suspected to contain an analyte, wherein the sample is deposited in an area in the device of any embodiment described in the disclosure;
(b) measuring the analyte in the sample, wherein the measuring involving one more operational variables that are random and unpredictable; and
(c) imaging a portion of the sample area wherein the portion is where the analyte is measured; and
(d) determining if the result measured in step (b) is trustworthy by analyzing the operational variables shown in the image of the portion of the sample.

Furthermore, if the analysis in step (d) determines that the result measured in step (b) is not trustworthy, the result is discarded.

### E. Assaying Using Multiple Assay Devices

E.1 In certain embodiments, multiple assay devices are used to perform the assaying, wherein the assay has a step of using an image analysis to check if an assay result is trustworthy, and wherein if a first assay device is found to be not trustworthy, a second assay device is used, until the assay result is found to be trustworthy.

In some embodiments, the sample is a biological or chemical sample.

In certain embodiments, in the step (d), the analysis uses machine learning with a training set to determine if a result is trustworthy, wherein the training set uses an operational variable with a known analyte in the sample.

In certain embodiments, in the step (d), the analysis uses a lookup table to determine if a result is trustworthy, wherein the lookup table contains an operational variable with a known analyte in the sample.

In certain embodiments, in the step (d), the analysis uses a neural network to determine if a result trustworthy, wherein the neural network is trained using an operational variable with a known analyte in the sample.

In certain embodiments, in the step (d), the analysis uses a threshold for the operational variable to determine if a result is trustworthy.

In certain embodiments, in the step (d), the analysis uses machine learning, lookup table or neural work to determine if a result is trustworthy, wherein the operational variables include a condition of air bubble and/or dust in the image of the portion of the sample.

In certain embodiments, in the step (d), the analysis uses machine learning, that determines if a result is trustworthy, use machine learning, lookup table or neural network to determine the operational variables of air bubble and/or dust in the image of the portion of the sample.

In some embodiments, the step (b) of measuring the analyte, the measuring uses imaging.

In some embodiments, the step (b) of measuring the analyte, the measuring uses imaging, and the same image used for analyte measurement is used for the trustworthy determination in step (d).

In some embodiments, the step (b) of measuring the analyte, the measuring uses imaging, and the same imager used for analyte measurement is used for the trustworthy determination in step (d).

In some embodiments, the device used in A1, B1, and/or C1 further comprised a monitoring mark.

The method, device, computer program product, or system of any prior embodiment, wherein the monitoring mark is used as a parameter together with an imaging processing method in an algorithm that (i) adjusting the imagine, (ii) processing an image of the sample, (iii) determining a property related to the micro-feature, or (iv) any combination of the above.

The method, device, computer program product, or system of any prior embodiment, wherein the monitoring mark is used as a parameter together with step (b).

The method, device, computer program product, or system of any prior embodiment, the spacers are the monitoring mark, wherein the spacers have a substantially uniform height that is equal to or less than 200 microns, and a fixed inter-spacer-distance (ISD);

In some embodiments of the present invention, the monitoring mark is used for estimating the TLD (true-lateral-dimension) and true volume estimation.

In certain embodiments, the step (b) further comprises an image segmentation for image-based assay.

In certain embodiments, the step (b) further comprises a focus checking in image-based assay.

In certain embodiments, the step (b) further comprises an Evenness of analyte distribution in the sample.

In certain embodiments, the step (b) further comprises an analyze and detection for aggregated analytes in the sample.

In certain embodiments, the step (b) further comprises an analyze for Dry-texture in the image of the sample in the sample.

In certain embodiments, the step (b) further comprises an analyze for Defects in the sample.

In certain embodiments, the step (b) further comprises a correction of camera parameters and conditions as distortion removal, temperature correction, brightness correction, contrast correction.

In certain embodiments, the step (b) further comprises methods and operations with Histogram-based operations, Mathematics-based operations, Convolution-based operations, Smoothing operations, Derivative-based operations, Morphology-based operations.

### F. System for Reliability Checking

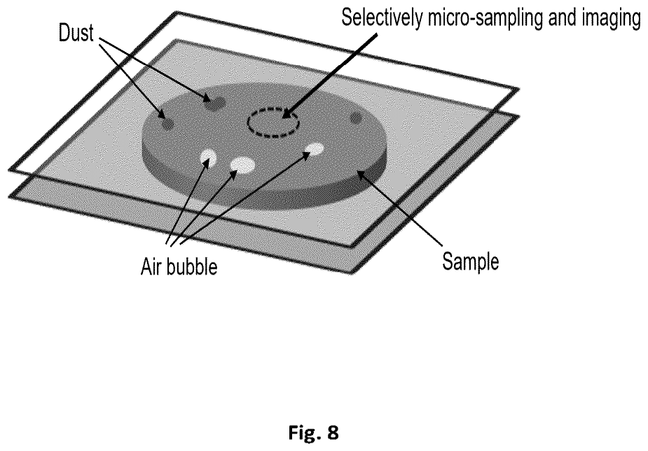

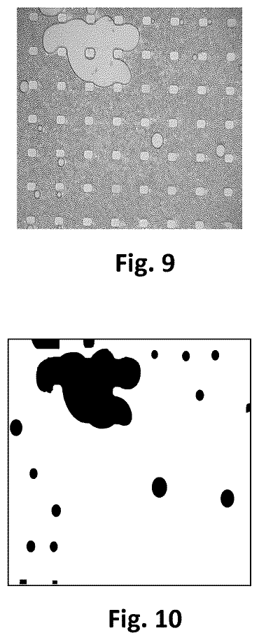

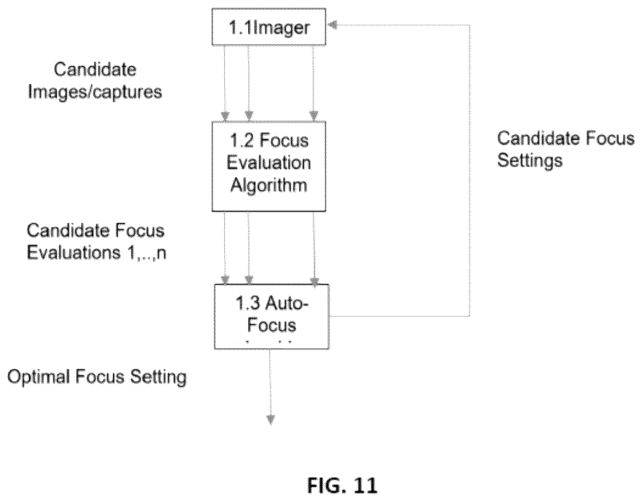

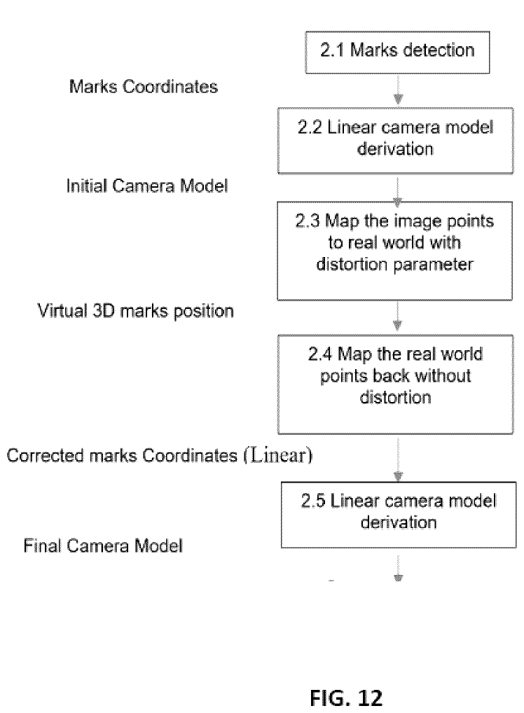

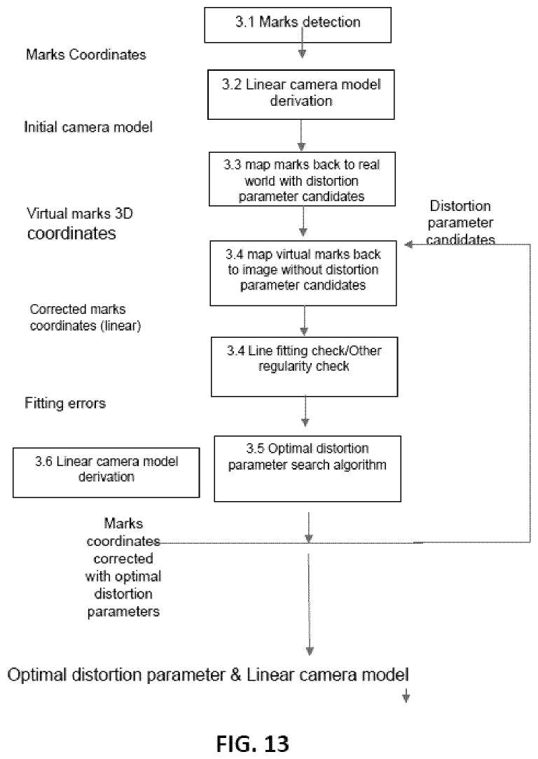

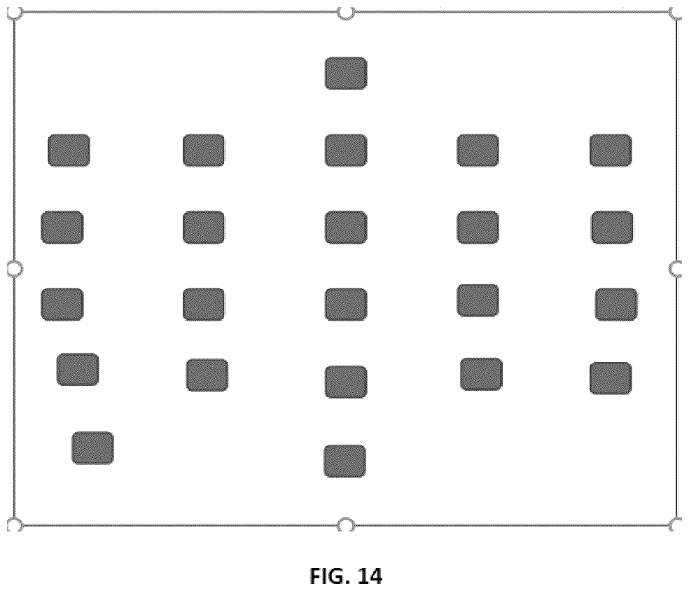

FIG. 8 is an illustrative diagram that defects, such as dusts, air bubbles, and so forth, can occur in the sample at the sample holder. FIG. 9 is an image of real blood sample that contains multiple defects occurred in an image-based assaying.

F1. A system for assaying a sample with one or more operation conditions unknown, comprising:
a) load the sample to a sample holding device, e.g. a QMAX device, whose gap is in proportion to the size of the analyte to be analyzed or the analytes form a mono-layer between the gap;
b) take an image of the sample in the sample holding device on the area-of-interest (AoI) for assaying with an imager;
c) segment the image of the sample taken by the said imager from (b) into equal-sized and non-overlapping sub-image patches (e.g. 8×8 equal-sized small image patches);
d) perform machine learning based inference with a trained machine learning model for analyte detection and segmentation on each image patch—to determine and not limited to the analyte count and concentration thereof;
e) sort the analyte concentration of the constructed sub-image patches in ascending order and determine the 25% quantile Q21 and 75% quantile Q3 thereof;
f) determine the uniformity of the analytes in the image of the sample with an inter-quantile-range based confidence measure: confidence-IQR=(Q3−Q1)/(Q3+Q1); and
g) if the confidence-IQR from (f) exceeds a certain threshold (e.g. 30%), raise the flag and the assay result is not trustworthy, wherein the said threshold is derived from the training/evaluation data or from the physical rules that govern the distribution of the analytes.
   F2. A system for assaying a sample with one or more operation conditions unknown, comprising:
a) load the assay into a sample holding device, e.g. a QMAX device, whose gap is in proportion to the size of the analyte to be analyzed or the analytes form a mono-layer between the gap;
b) take an image of the sample in the sample holding device on the area-of-interest (AoI) for assaying with an imager;
c) perform machine learning based inference with a trained machine learning model for dry texture detection and segmentation—to detect the dry texture areas and determine the area-dry-texture-in-AoI associated with the segmentation contour masks that cover those areas of dry-texture in the AoI of the image of the sample;
d) determine the area ratio between the area-dry-texture-in-AoI and the area-of-the-AoI: ratio-dry-texture-area-in-AoI=area-dry-texture-in-AoI/area-of-AoI; and
h) if the ratio-dry-texture-area-in-AoI from (d) exceeds a certain threshold (e.g., 10%), raise the flag and the assay result is not trustworthy, wherein the said threshold is derived from the training/evaluation data or from the physical rules that govern the distribution of the analytes.
   F3. A system for assaying a sample with one or more operation conditions unknown, comprising:
a) load the assay into a sample holding device, e.g., a QMAX device, whose gap is in proportion to the size of the analyte to be analyzed or the analytes form a mono-layer between the gap;
b) take an image of the sample in the sample holding device on the area-of-interest (AoI) for assaying with an imager;
c) perform machine learning based inference with a trained machine learning model for aggregated analytes detection and segmentation—to detect the clustered analytes and determine the area (area-aggregated-analytes-in-AoI) associated with the segmentation contour masks that cover them in the AoI thereof;
d) determine the area ratio between the area-aggregated-analytes-in-AoI and the area-of-AoI: ratio-aggregated-analytes-area-in-AoI=area-aggregated-analytes-in-AoI/area-of-AoI; and
i) if the ratio-aggregated-analytes-area-in-AoI from (d) exceeds a certain threshold (e.g. 40%), raise the flag and the assay result is not trustworthy, wherein the said threshold is derived from the training/evaluation data or from the physical rules that govern the distribution of the analytes.
   F4. A system for assaying a sample with one or more operation conditions unknown, comprising:
a) load the assay into a sample holding device, e.g., a QMAX device, whose gap is in proportion to the size of the analyte to be analyzed or the analytes form a mono-layer between the gap;
b) take an image of the sample in the sample holding device on the area-of-interest (AoI) for assaying with an imager;
c) perform machine learning based inference with a trained machine learning model for detection and segmentation of the defects in the image of the sample, wherein the defects include and not limited to dusts, oil, etc.—to detect the defects and determine the area (area-defects-in-AoI) associated with the segmentation contour masks that cover them in the AoI thereof;
d) determine the ratio between the area-defects-in-AoI and the area-of-AoI: ratio-defects-area-in-AoI=area-defects-in-AoI/area-of-AoI; and
j) e) if the ratio-defects-area-in-AoI from (d) exceeds a certain threshold (e.g., 15%), raise the flag and the assay result is not trustworthy, wherein the said threshold is derived from the training/evaluation data or from the physical rules that govern the distribution of the analytes.
   F5. A system for assaying a sample with one or more operation conditions unknown, comprising:
a) load the assay into a sample holding device, e.g., a QMAX device, whose gap is in proportion to the size of the analyte to be analyzed or the analytes form a mono-layer between the gap;
b) take an image of the sample in the sample holding device on the area-of-interest (AoI) for assaying with an imager;
c) perform machine learning based inference with a trained machine learning model for air bubble and air gap detection and segmentation—to detect air bubbles and air gaps and determine area-airbubble-gap-in-AoI associated with the segmentation contour masks that cover them in the AoI thereof:
d) determine the area ratio between the area-airbubble-gap-in-AoI and the area-of-AoI:
   ratio-airbubble-gap-area-in-AoI=area-airbubble-gap-in-AoI/area-of-AoI; and
k) if the ratio-airbubble-gap-area-in_AoI from (d) exceeds a certain threshold (e.g. 10%), raise the flag and the assay result is not trustworthy, wherein the said threshold is derived from the training/evaluation data or from the physical rules that govern the distribution of the analytes.
   F6. A system for assaying a sample with one or more operation conditions unknown, comprising:
a) load the assay into a sample holding device, e.g. a QMAX device, wherein the said sample holding device has a gap in proportion to the size of the analyte to be analyzed or the analytes form a mono-layer between the gap, and there are monitor marks (e.g. pillars)-residing in the device and not submerged, that can be imaged by an imager on the sample holding device with the sample;
b) take an image of the sample in the sample holding device on the area-of-interest (AoI) for assaying with an imager;
c) perform machine learning based inference with a trained machine learning model to detect and segment the monitor marks (pillars) with analytes on top—to determine the area (area-analytes-on-pillars-in-AoI) associated with the detected monitor marks (pillars) based on their segmentation contour masks in the AoI;
d) determine the area ratio between the area-analytes-on-pillars-in-AoI and the area-of-AoI: ratio-analytes-on-pillars-area-in-AoI=area-analytes-on-pillars-in-AoI/area-of-AoI; and
l) if the ratio-analytes-on-pillars-area-in-AoI from (d) exceeds a certain threshold (e.g. 10%) raise the flag and the assay result is not trustworthy, wherein the said threshold is derived from the training/evaluation data or from the physical rules that govern the distribution of the analytes.
   F7. A system for assaying a sample with one or more operation conditions unknown, comprising:
a) load the assay into a sample holding device, e.g. a QMAX device;
b) take an image of the sample in the sample holding device on the area-of-interest (AoI) for assaying with an imager;
c) perform machine learning based focus check to detect if the image of the sample taken by the imager is in focus to the sample, wherein the machine learning model for detecting the focus of the said imager is built from the multiple images of the imager with known in focus and off focus conditions; and
d) if the image of the sample taken by the said imager is detected off focus from (c), raise the flag and the image-based assay result is not trustworthy.
   F8. A system for assaying a sample with one or more operation conditions unknown, comprising:
a) load the assay into a sample holding device, e.g., a QMAX device;
b) take an image of the sample in the sample holding device on the area-of-interest (AoI) for assaying with an imager;
c) perform machine learning based analyte detection; and
d) if the analyte count is extremely low beyond a preset acceptable range, raise the flag and the result is not trustworthy, wherein the acceptable range is specified based on physical or biological conditions of the assay.
   F9. A system for assaying a sample with one or more operation conditions unknown, comprising:
a) load the assay into a sample holding device, e.g., a QMAX device;
b) take an image of the sample in the sample holding device on the area-of-interest (AoI) for assaying with an imager;
c) partition the image of the sample into non-overlapping, equal sized sub-image patches;
d) perform machine learning based analyte detection over each sub-image patch thereof; and
e) if for some sub-image patches, the count of the detected analytes is unrealistically low (e.g., in complete-blood-count, the number of red blood cell in the sample is below human acceptable range), raise the flag and the result is not trustworthy for having not enough samples or non-uniform distribution of the sample in the assay.
   F10. In methods, apparatus and embodiments in all prior embodiments, wherein the detection and segmentation of abnormalities from the image of the sample taken by the imager in the image-based assay are based on image processing, machine learning or a combination of image processing and machine learning.
   F11. In methods, apparatus and embodiments in all prior embodiments, the estimation of the area covered by segmentation contour masks in the area-of-interest (AoI) of the image of the sample utilizes a per-image or per-sub-image patch based true-lateral-dimension (or Field-of-View (FoV)) estimation to compensate the distortions in microscopic imaging, including and not limited to spherical distortion from the lens, defects at microscopic level, mis-alignment in focusing, etc.
   F12. In methods, apparatus and embodiments of F11, there are monitor marks (e.g., pillars) built in with the sample holding device, e.g., QMAX card; and the said monitor marks (e.g., pillars) are applied as detectable anchors to make the estimation of the true-lateral-dimension (or Field-of-View (FoV)) estimation accurate in face of the distortions in microscopic imaging.
   F13. In methods, apparatus and embodiments of F12, the monitor marks (e.g., pillars) of the sample holding device have some known configurations with a prescribed periodic distribution in the sample holding device, e.g., QMAX card, to make detection and location of the monitor marks as anchors in true-lateral-dimension (TLD) (or Field-of-View (FoV)) estimation reliable and robust.
   F14. In methods, apparatus and embodiments of F1, the detection and characterization of the outliers in the image-based assay are based on the non-overlapping sub-image patches of the input image of the sample described herein, and the determination of the outliers can be based on non-parametric methods, parametric methods and a combination of both in the assaying process.
   G-1 A method, comprising:
(a) detecting an analyte in a sample that comprises or is suspected of comprising the analyte, said detecting comprising:
   (i) depositing the sample into a detection instrument, and
   (ii) measuring the sample using the detection instrument to detect the analyte, thereby generating a detection result;
(b) determining a reliability of the detection result, said determining comprising:
   (i) taking one or more images of a portion of the sample and/or a portion of the detection instrument adjacent the portion of the sample, wherein the one or more images reflect one or more operation conditions under which the detection result was generated; and
   (ii) using a computational device with an algorithm to analyze the one or more images to determine a reliability of the detection result in step (a); and
(c) reporting the detection result and the reliability of the detection result;

wherein the one or more operation conditions are unpredictable and/or random.

The term of “unreliable” in an assay's result means that for assaying a given sample, the results of the assay are not always accurate: sometimes the results of the assay are accurate, but other times the results are inaccurate, wherein the inaccurate results are substantially different from accurate results. Such inaccurate result is termed “erroneous result”. In some literatures, the erroneous results are also termed “outliers”.

The term of “accurate” in an assay's result means that the result of the assay agrees, within an allowed arrange, with the result of the same sample assayed by a gold standard instrument, operated by a trained professional, under an ideal environment.

Traditionally, diagnostic assays usually are performed using sophisticated (often expensive) instruments and require highly trained personnel and sophisticated infrastructures, which are not available in limited resource settings.

The term “a limited resource setting” or “LRS” for assaying a sample refers to a setting in performing an assay, wherein it uses a simplified/low cost assay process or a simplified/low cost instrument, is performed by an untrained person, is used in an adverse environment (e.g., open and non-lab environment with dusts), or any combination of thereof.

The term “LRS assay” refers to an assay performed under LRS.

The term “trustworthy” in describing a reliability of a particular assay result (or data) refers to a reliability analysis of the particular assay result determines that the result has a low probability of being inaccurate.

The term “untrustworthy” in describing a reliability of a particular assay result (or data) refers to a reliability analysis of the particular assay result determines that the result has a high probability of being inaccurate.

The term “operation conditions” in performing an assay refers to the conditions under which an assay is performed. The operation conditions include, but not limited to, the air bubble in a sample, the dust in a sample, the foreign objects (i.e., the objects that are not from the original sample, but comes into the sample later), the defects of the solid phase surface, and/or handing conditions of the assay.

When assaying a sample in a limited resource setting (LRS), a result from the assaying can be unreliable. However, traditionally, there is no checking on the reliability of a particular result during or after a particular testing for a given sample.

The present invention observes that in LRS assaying (or even in the lab testing environment), one or more unpredictable random operation conditions can occur and affect the assaying result. When that happens, it can be substantially different from one particular assaying to next assaying, even using the same sample. However, instead of taking the assaying result as it is, the reliability of a particular result in a particular testing for a given sample can be assessed by analyzing one or more factors that are related to the assay operation conditions in that particular assay.

The present invention observes that in LRS assaying that has one or more unpredictable random operation conditions, the overall accuracy of the assaying can be substantially improved by using an analysis on the reliability of each particular assaying and by rejecting the untrustworthy assay results.

One aspect of the present invention is the devices, system and the methods that perform an assay by not only measuring the analytes in a particular test, but also checking the trustworthy of the measuring result through an analysis of the operation conditions of that particular test.

In some embodiments of the present invention, the checking of the trustworthy of the measuring result of the assay is modeled in a machine learning framework, and machine learning algorithms and models are devised and applied to handle unpredictable random operation conditions that occur and affect the assay result.

The term “machine learning” refers to algorithms, systems and apparatus in the field of artificial intelligence that often use statistical techniques and artificial neural network to give computer the ability to “learn” (i.e., progressively improve performance on a specific task) from data without being explicitly programmed.

The term “artificial neural network” refers to a layered connectionist system inspired by the biological networks that can “learn” to perform tasks by considering examples, generally without being programmed with any task-specific rules.

The term “convolutional neural network” refers to a class of multilayer feed-forward artificial neural networks most commonly applied to analyzing visual images.

The term “deep learning” refers to a broad class of machine learning methods in artificial intelligence (AI) that learn from data with a network structure consisting of many connected layers.

The term “machine learning model” refers to a trained computational model that is built from a training process in the machine learning from the data. The trained machine learning model is applied during the inference stage by the computer that gives computer the capability to perform certain tasks (e.g., detect and classify the objects) on its own. Examples of machine learning models include ResNet, DenseNet, etc. which are also named as “deep learning models” because of the layered depth in their network structure.

The term “image segmentation” refers to an image analysis process that partitions a digital image into multiple segments (sets of pixels, with a set of bit-map masks that cover the image segments along their segmentation boundary contours). Image segmentation can be achieved through the image segmentation algorithms in image processing, such as watershed, grabcuts, mean-shift, etc., and can also be achieved through machine learning algorithms, such as MaskRCNN.

The term “object” or “object of interest” in an image means an objection that is visible in the image and that has a fixed shape or form.

In present invention, the innovative use of machine learning has the advantage of automating the process of determining the trustworthy of the assay result in face of unpredictable random operation conditions in assaying-directly from the data without making explicit assumptions on the unpredictable conditions which can be complex, hard to predict, and error prone.

The machine learning framework in the present invention involves a process that comprises:
(a) gather training data of the task;
(b) prepare the data with labeling;
(c) select a machine learning model;
(d) train the selected machine learning model with the training data;
(e) tune the hyper-parameters and model structure with the training and evaluation data until the model reaches a satisfactory performance on the evaluation and test data; and

(f) perform the inference on the test data using the trained machine learning model from (e).

Image segmentation for image-based assay: In some embodiments of the present invention for verifying the trustworthy of the test results, it needs to segment the objects of interest from the image of the sample for assaying. Although machine learning based image segmentation algorithms, such as Mask RCNN, is powerful, they require precise contour labeling of the shape of the objects in the microscopic image of the sample to train the machine learning model, which has become a bottleneck for many applications. Moreover, they are very sensitive to the shapes of the objects in the image. For image-based assay, such labeling of the shape contour of the objects is hard to come by, because objects in the sample can be very small, their occurrences are random, and moreover, there are huge variations among them in shape, size and colorations (e.g., dusts, air bubbles, etc.).

In some embodiments of the present invention, a fine-grinned image segmentation algorithm is devised based on a combination of a machine learning based coarse bonding box segmentation and an image processing based fine grind shape determination. It is applied to the image segmentation in the image-based assay, wherein each object only needs to be labeled in a rough bounding box-independent of its shape and shape contour details. By which, it eliminates the need of the fine labeling of the shape dependent contour of the objects in the image of the sample, which is difficult, complex, costly and hard to be accurate. This fine-grinned image segmentation algorithm comprises:
a) collecting multiple images of the sample taken by the imager which contains the objects to be detected in the image of the sample for further assaying;
b) labeling each object in the collected images with a rough bonding box that contains the said object for model training;
c) training a machine learning model (e.g., FRCNN) to detect the said objects in the image of the sample with rough bounding boxes that contain them;
d) taking the image of the sample as input in assaying;
e) applying the trained machine learning model to detect the said objects with their rough bounding boxes in the image of the sample;
f) transforming each image patch corresponding to a detected bonding box into gray color and then to binary with an adaptive thresholding;
g) performing morphological dilation (7×7) and erosion (3×3) to enhance the contour of the shape from the background noise;
h) performing convex contour analysis on each said image patch and using the longest connected contour find in the patch as the contour of the object shape to determine the image mask of the object (e.g., binary bit map that covers the object in the image of the sample); and
i) completing the image segmentation by collecting all image masks from (h). (if segmentation masks with an extra margin A is needed, dilate each detected contour in (h) with margin A as new masks)

FIG. 10 is an example of the described fine-grinned image segmentation algorithm applied to the image of the blood sample depicted in FIG. 9 in the image-based assay. As illustrated in the example, the described fine-grinned image segmentation algorithm can handle objects with different size and shape properly in the image-based assay with very tight masks covering the objects in the image of the sample.

Focus checking in image-based assay: In image-based assay, the image of the sample taken by the imager needs to be in focus on the sample by the imager for assaying, and off focus in the image of the sample taken by the imager blurs analytes in the image of the sample, and consequently, the assaying results become untrustworthy. However, there are many random factors that can cause the image of the sample being partially or even totally off focus, including and not limited to vibrations/hand-shaking during the image taken, the mis-placement of the sample holding device with the image sensor plane, etc. Moreover, prior art mostly relies on certain edge content-based measure, e.g., Tenengrad, etc., and some preset content dependent thresholds, which are unreliable, fragile, and falls short for the requirements in microscopic imaging based assay.

In some embodiments of the present invention, a verification process based on machine learning is devised and applied to determine if an image of the sample taken by an imager in the image-based assay is in focus or off focus, wherein the image of the samples taken by the imager under both in focus and off focus conditions are collected as training data, and they are labeled based on their known focus conditions. A machine learning model is selected and it is trained with the labeled training data. During the assaying process, the trained machine learning model is applied to the image of the sample taken by the imager to infer/predict if the image of the sample taken by the imager for assaying is in focus and to decide if the assaying result is trustworthy without requiring the preset and content dependent thresholds as in prior art.

In some embodiments, the monitor marks in the form of pillars are on the sample holding QMAX card to keep the gap between the two parallel plates of the sample holding QMAX card uniform. As such, the volume of the sample under the area-of-interest (AoI) in the image taken by the imager on the sample holding QMAX card can be determined by the AoI and the said gap between the two parallel plates thereof.

Evenness of analyte distribution in the sample: One factor that can affect the trustworthy of the assaying results is the evenness of the analytes distributed in the sample, and they are hard to detect by eyeball checking even with the experienced technicians.

In some embodiments of the present invention, an algorithm with a dedicated process based on machine learning is devised and applied to determine if analytes are distributed evenly in the sample for assaying from the image of the sample taken by the imager, wherein multiple images of samples taken by the imager are collected, from which analytes in the image of the sample are identified and labeled. A machine learning model (e.g., F-RCNN) is selected and it is trained with the labeled training images to detect the analytes in the image of the sample.

During the assaying process, the algorithm with its dedicated process comprises:
a) taking the image of the sample from the imager as input;
b) segmenting the image of the sample into equal-sized and non-overlapping image patches (e.g. 8×8 equal-sized small image patches);
c) applying the trained machine learning model to each constructed image patch to determine and not limited to the analyte concentration in each patch;
d) sorting the analyte concentration of the constructed image patches in ascending order and determining its 25% quantile Q1 and 75% quantile Q3 in the sorted concentration sequence of the constructed image patches;
e) applying a robust, non-parametric outlier detection algorithm to determine the evenness/uniformity of the analytes in the sample for assaying—from the analyte concentration distribution of the constructed image patches, wherein an inter-quantile-range based confidence measure is constructed and applied in some of the present invention:

confidence-IQR=(Q3−Q1)/(Q3+Q1); and

if the confidence-IQR exceeds a certain threshold (e.g., 30%), raise the flag and the assay result is not trustworthy, wherein the threshold depends on the influence of the uneven distribution to the final estimation which can be estimated from the training and evaluation data

Aggregated analytes in the sample: In addition, aggregated analytes in the sample can affect the accuracy of the assaying results, especially they occupy a significant portion of the sample. For example, in complete blood count, certain portion of the red blood cells can be aggregated in the sample, especially if they are exposed in the open air for certain period of time. Aggregated analytes in the sample have various size and shape depending on how they are aggregated together. If the portion of the aggregated analytes exceeds a certain percentage in the sample, the sample should not be used for assaying.

In some embodiments of the present invention, a process based on machine learning is devised and applied to determine if analytes are aggregated/clustered in the sample for assaying from the image of the sample taken by the imager, wherein images of good samples and images of samples with various degrees of aggregated analytes in the sample are taken by the imager and collected as training data. Following the fine-grinned image segmentation algorithm described in the present invention, the aggregated analytes in the image are roughly labeled by bounding boxes first, regardless of their shape and shape contour details. A machine learning model (e.g., Fast RCNN) is selected and trained with the labeled training images—to detect the aggregated analyte clusters in the image of the sample with their bonding boxes, and after that, additional processing steps are performed to determine their fine grinned segmentation based on the described fine grinned image segmentation algorithm in the present invention.

During the assaying process, the operations for aggregated analytes are performed, comprising:
a) taking the image of the sample from the imager as input;
b) applying the trained machine learning model for aggregated analytes to detect the aggregated analytes in the image pf the sample for assaying in bonding boxes;
c) determining their segmentation contour masks in the image of the sample following the described fine grinned image segmentation algorithm in the present invention;
d) determining the total area (area-aggregated-analytes-in-AoI) occupied by the aggregated analytes in the area-of-interest (AoI) in the image of the sample, by summing up all areas associated with the segmentation contour masks that cover them from (c);
e) determining the area ratio between the area-aggregated-analytes-in-AoI and the area-of-AoI in the image of the sample:
   ratio-aggregated-analytes-area-in-AoI=area-aggregated-analytes-in-AoI/area-of-AoI; and
f) raising flag on the trustworthy of the assaying results, if the ratio-aggregated-analyles-area-in-AoI exceeds a certain threshold, wherein in some embodiments of the described approach, the threshold is around 10-20%, wherein the threshold depends on the influence of the aggregated analytes area to the final estimation, which can be estimated from the training and evaluation data.

Dry-texture in the image of the sample: Dry-texture in the image of the sample is another factor that affects the trustworthy of the assaying results in image-based assay. This happens when the amount of the sample for assaying is below the required amount or certain portion of the sample in the image holding device dried out due to some unpredictable factors.

In some embodiments of the present invention, a process based on machine learning is devised and applied to detect dry-texture areas in the image of the sample taken by the imager in the image-based assay, wherein images of good samples without the dry-texture areas and images of samples with various degrees of dry-texture areas in the sample are collected as training data—from which dry-texture areas in the image are labeled roughly by bonding boxes, regardless of the shape and shape contour details. A machine learning model (e.g., Fast RCNN) is selected and trained with the labeled training images—to detect the dry-texture areas in the image of the sample with bonding boxes, and then following the described fine-grinned image segmentation algorithm in the present invention to determine the segmentation contour masks that covering them.

During the image-based assaying process, it performs the following processing operations, comprising:
a) taking the image of the sample from the imager as input;
b) applying the trained machine learning model (e.g., Fast RCNN) for dry-texture to the image of the sample for assaying, and detecting the dry-texture areas thereof in bonding boxes;
c) determining the segmentation contour masks by the described fine-grinned image segmentation algorithm in the present invention if there are dry-texture areas detected in the image of the sample in (b);
d) determining the total areas occupied by the dry-texture in the area-of-interest (AoI) (area-dry-texture-in-AoI) in the image of the sample for assaying, by summing up all areas of the detected dry-texture based on the segmentation contour masks that cover them in (c);
e) determining the area ratio between the area-dry-texture-in-AoI and the area-of-AoI in the image of the sample:
   ratio-dry-texture-area-in-AoI=area-dry-texture-area-in-AoI/area-of-AoI; and
f) raising the flag on the trustworthy of the assaying results, if the ratio-dry-texture-area-in-AoI exceeds a certain threshold, wherein in some embodiments of the described approach, the threshold is around 10%, wherein the threshold depends on the influence of dry-texture area to the final estimation, which can be estimated from the training and evaluation data.

Defects in the sample: Defects in the sample can seriously affect the trustworthy of the assaying results, wherein these defects can be any unwanted objects in the sample, including and not limited to dusts, oil, etc. They are hard to handle with prior art, because their occurrences and shapes in the sample are all random.

In some embodiments of the present invention, a dedicated process for defects detection is devised and applied to image-based assay, wherein images of good samples without the defects and images of samples with various degree of defects in the sample are collected as training data—from which defect areas in the image are labeled with a rough bonding box labeling. A machine learning model (e.g., Fast RCNN) is selected and trained with the labeled training images—to detect the defects in the image of the sample in bonding boxes, and following that the described fine-grinned image segmentation algorithms in the present invention are applied to determine the segmentation contour masks that covering them.

During the image-based assaying process, defects detection and area determination are performed to verify the trustworthy of the assaying results, comprising:
a) taking the image of the sample from the imager as input;
b) applying the trained machine learning model (e.g., Fast RCNN) for defects to the image of the sample for assaying, and detecting the defects thereof in bonding boxes;
c) determining their segmentation contour masks following the described fine-grinned image segmentation algorithm in the present invention;
d) determining the total areas occupied by the defects in the area-of-interest (AoI) (area-defects-in-AoI) in the image of the sample for assaying, by summing up all areas of detected defects based on the segmentation contour masks that cover them from (c);
e) determining the area ratio between the area-defects-in-AoI and the area-of-AoI in the image of the sample:
   ratio-defects-in-AoI=area-defects-in-AoI/area-of-AoI; and
f) raising the flag on the trustworthy of the assaying results, if the ratio-defects-in-AoI exceeds a certain threshold, wherein in some embodiments of the described approach, the threshold is around 15%, wherein the threshold depends on the influence of the area of defects to the final estimation, which can be estimated from the training and evaluation data.

Air bubbles in the sample: Air bubbles in the sample is a special type of defects occurring in assaying. Their occurrences are random-which can come from the operation procedures as well as the reactions between the analytes and other agents in the sample. Unlike the solid dusts, their occurrences are more random as their numbers, sizes and shapes can all vary with time.

In some embodiments of the present invention, a dedicated process is devised and applied to detect air bubbles in the sample in the image-based assay, wherein images of good samples without air bubbles and images of samples with various degree of air bubbles are collected as training data—from which air bubbles in the image are only roughly labeled by bounding boxes, regardless of their shape and shape contour details. A machine learning model (e.g., Fast RCNN) is selected and trained with the labeled training images—to detect the air bubbles in the image of the sample in bonding boxes. Then following the described fine-grinned image segmentation algorithm in present invention, it determines the segmentation contour masks that covering them in the image of the sample.

During the image-based assaying process, air bubbles detection and area determination are performed in some embodiments of the present invention, to verify the trustworthy of the assaying results, comprising:
a) taking the image of the sample from the imager as input;
b) applying the trained machine learning model (e.g., Fast RCNN) for air bubbles to the image of the sample for assaying, and detecting the air bubbles in bonding boxes;
c) determining their segmentation contour masks by applying the described fine grinned image segmentation algorithm in the present invention;
d) determining the total areas occupied by the air bubbles in the area-of-interest (AoI) (area-defects-in-AoI) in the image of the sample for assaying, by summing up all areas of detected air bubbles based on the segmentation contour masks that cover them in (c);
e) determining the area ratio between the area-air-bubbles-in-AoI and the area-of-AoI in the image of the sample:
   ratio-air-bubbles-in-AoI=area-air-bubbles-in-AoI/area-of-AoI; and
f) raising the flag on the trustworthy of the assaying results, if the ratio-air-bubbles-in-AoI exceeds a certain threshold, wherein in some embodiments of the described approach, the threshold is around 10%, wherein the threshold depends on the influence of air bubble areas to the final estimation, which can be estimated from the training and evaluation data.

In some embodiments of the present invention, a tighter threshold on air bubbles is applied, because a large amount of areas occupied by air bubbles is an indication of some chemical or biological reactions among the components in the sample for assaying or some defects/issues in the sample holding device.

We claim:

1. A system for improving the accuracy of an assay device that detects an analyte in a sample, wherein the sample, the assay device, or an operation of the assay device has one or more imperfect conditions, the system comprising:
(a) an assay device that detects, under the one or more imperfect conditions, the analyte in the sample to generate a detection result, wherein the assay device has a sample holder that holds the sample;
(b) an imager that images the sample in the sample holder to obtain images;
(c) a non-transitory storage medium that stores an algorithm that analyzes the image(s) and a reliability of the detection result to generate a trustworthiness of the detection results, wherein the trustworthiness is higher when the analysis of the reliability shows that the detection result has a lesser likelihood of being inaccurate, and wherein the algorithm comprises at least a machine learning algorithm, a statistical model, a lookup table, or any combination of;
(d) a cloud that executes the algorithm to determine the trustworthiness of the detection result.

2. A apparatus for improving the accuracy of an image-based assay device that detects an analyte in a sample, wherein the assay device has an optical system with a distortion, the apparatus comprising:
(a) a sample holder having a sample contact surface, wherein one or more monitoring marks on the sample on the sample contact surface, wherein the monitoring marks have a first set of parameters predetermined during the manufacturing of the sample holder;
(b) an optical system of the assay device to take one or more images of the sample in the sample holder together with the monitoring marks, wherein the monitoring marks having a second set of parameters in the images; and
(c) a processor with a non-transitory storage medium that stores an algorithm that process the one or more images and correct distortion of the optical system by using the algorithm and the first set and the second set of the parameters.

3. An apparatus for improving the accuracy of an assay device that detects an analyte in a sample, wherein the sample, the assay device, or the operation of the assay device has one or more imperfect condition, the apparatus comprising:
(a) an assay device that detects the analyte in the sample to generating a detection result, wherein the assay device has a sample holder, and
(b) an imager that images the sample in the sample holder.
